(19) United States
(12) Patent Application Publication
(10) Pub. No.: US 2014/0244131 A1
(43) Pub. Date: Aug. 28, 2014

(54) METHOD FOR OPERATING A DRIVER ASSISTANCE SYSTEM OF A MOTOR VEHICLE WITH A COMBINED LONGITUDINAL AND TRANSVERSE GUIDANCE FUNCTION

(71) Applicant: AudiAG, 85045 Ingolstadt (DE)

(72) Inventors: WOLFGANG MIELICH, Ingolstadt (DE); MANFRED HOLZMANN, Greding (DE); REGINA MEIER, Ingolstadt (DE)

(73) Assignee: AudiAG, 85045 Ingolstadt (DE)

(21) Appl. No.: 14/189,459

(22) Filed: Feb. 25, 2014

(30) Foreign Application Priority Data
Feb. 26, 2013 (DE) 10 2013 003 187.7

(51) Int. Cl. B60W 30/00; B60W 10/18; B60W 10/20; B60W 10/06

(52) U.S. Cl. CPC B60W 30/00; B60W 10/06; B60W 10/18; B60W 10/20
USPC 701/99; 701/1

(57) ABSTRACT

Method for operating a driver assistance system of a motor vehicle having a combined longitudinal and transverse guidance function, wherein, starting from the combined operation of the longitudinal and transverse guidance function, the longitudinal guidance function is disconnected in response to the presence of at least one determined first disconnection condition, whereas the transverse guidance function is maintained.

### CROSS-REFERENCES TO RELATED APPLICATIONS

This application claims the priority of German Patent Application, Serial No. 10 2013 003 187.7, filed Feb. 26, 2013, pursuant to 35 U.S.C. 119(a)-(d), the content of which is incorporated herein by reference in its entirety as if fully set forth herein.

### BACKGROUND OF THE INVENTION

The present invention relates to a method for operating a driver assistance system of a motor vehicle having a combined longitudinal and transverse guidance function.

The following discussion of related art is provided to assist the reader in understanding the advantages of the invention, and is not to be construed as an admission that this related art is prior art to this invention.

Such driver assistance systems are used for combined or simultaneous and in particular automated longitudinal and transverse guidance of a motor vehicle. The motor vehicle can thus be guided in a travel lane by the driver assistance system in both the longitudinal and transverse direction, so that the driver can be assisted in typical driving tasks occurring during driving maneuvers, such as in particular steering and accelerating operations.

Corresponding driver assistance systems typically couple or link the longitudinal and transverse guidance function, meaning that the longitudinal guidance function can only be activated and deactivated or connected and disconnected in combination with the transverse guidance function. However, there exists a problem in that the driver is immediately confronted, when deactivating the driver assistance system, with a number of driving tasks, i.e. in particular steering and acceleration maneuvers that affect the longitudinal and transverse control of the motor vehicle. This frequently represents a complex and demanding process for the driver.

It would therefore be desirable and advantageous to obviate prior art shortcomings and to provide an improved method for operating a driver assistance system of a motor vehicle having a combined longitudinal and transverse guidance function.

### SUMMARY OF THE INVENTION

According to one aspect of the present invention, a method for operating a driver assistance system of a motor vehicle having a combined longitudinal and transverse guidance function of the motor vehicle includes operating the longitudinal and transverse guidance function in combination, and disconnecting the longitudinal guidance function in response to at least one first disconnection condition, while maintaining the transverse guidance function.

The principle according to the invention proposes to decouple the longitudinal guidance function from the transverse guidance function of a driving assistance system, so that the driving assistance system can be operated at least temporarily only with a transverse guidance function taking over the transverse guidance of the motor vehicle, in particular in a fully automated fashion. The longitudinal guidance function taking over the longitudinal guidance of the motor vehicle can hence be temporarily deactivated or disconnected. For this purpose, within the context of the present invention, the existence of at least one first disconnection condition may be checked continuously or at specified, in particular regular points in time, while the motor vehicle is guided both longitudinally and transversely by the longitudinal guidance function and the transverse guidance function.

In principle, parameters associated in particular directly or indirectly with the operation of the motor vehicle are determined and examined in the combined longitudinal and transverse guidance operation of the driver assistance system to assess whether they satisfy the first disconnection condition. When the first disconnection condition is satisfied by, for example, one or more parameters, the longitudinal guidance function is disconnected, whereas the transverse guidance function is (initially) maintained. The inventive method thus allows a reduction of the functionality of the driver assistance system to the transverse guidance function depending on the presence of the first disconnection condition due to the decoupling of the operating states of the longitudinal guidance function from the transverse guidance function of driver assistance system.

According to an advantageous feature of the present invention, the driver assistance system may take over, in addition to the combined longitudinal and transverse guidance function, only a transverse guidance function, when the first disconnection condition is satisfied.

The driver is thus unburdened, because he can now initially concentrate, due to the sole deactivation of the longitudinal guidance function, on only one driving task, i.e. taking over the independent longitudinal guidance of the motor vehicle.

According to another advantageous feature of the present invention, the driver may also take over again the transverse guidance of the motor vehicle in addition to the longitudinal guidance, wherein the operation of the driver assistance system is then completely deactivated. Consequently, in an advantageous embodiment of the invention, the transverse guidance function is additionally disconnected, starting when the driver assistance system is operated with a deactivated longitudinal guidance function and in the presence of a second determined disconnection condition. Accordingly, the driver assistance system can be completely deactivated in two stages, wherein in the first stage only the longitudinal guidance function is disabled in the presence of the first disconnection condition, and in a subsequent second stage the transverse guidance function is additionally disabled in the presence of the second disconnection condition.

In principle, the presence of the first disconnection condition(s) causes the longitudinal guidance function to be disconnected and the presence of the second disconnection condition(s) causes additional disconnection of the transverse-guidance function of driver assistance system.

According to another advantageous feature of the present invention, several first disconnection conditions may exist, wherein starting from the combined operation of the longitudinal and transverse guidance function, the single or group-wise presence of these disconnection conditions causes disconnection or deactivation of the longitudinal guidance function of the driver assistance system.

Advantageously, operating parameters of the motor vehicle may be used as the first disconnection condition. For example, current or projected driving speed values of the motor vehicle and/or current or projected acceleration or deceleration of the motor vehicle and/or current or projected engine speeds may be used as operating parameters. It is therefore conceivable, for example, to consider the first disconnection condition as being satisfied and thus present when the driving speed of the motor vehicle exceeds or falls below a certain speed range. For example, the first disconnection condition may be deemed to be present when the vehicle drives slower than a certain limit value of the driving speed, for example, a driving speed of 30 km/h. The first disconnection condition may also be deemed to be present case, when the engine speed drops below a certain limit value, such as 1500 revolutions per minute.

According to another advantageous feature of the present invention, the first disconnection condition may be at least one operating state of the driver assistance system and/or of at least one additional driver assistance system of the motor vehicle and/or a vehicle safety system. For example, a first disconnection condition for disconnecting the longitudinal guidance function may exist when an operation state of the driver assistance system indicates that the longitudinal guidance function cannot be performed at all or can be performed only with certain limitations, for example due to a malfunction of the driver assistance system, in particular its longitudinal guidance function, and/or of a component operatively connected to the driver assistance system, such as brakes, clutches, the engine. It may also be possible or necessary, based on determined operating conditions of other driver assistance systems, for example in situations where safe operation of the motor vehicle is ensured by the operation of other driver assistance systems of the motor vehicle or of vehicle safety systems, to disconnect the longitudinal guidance function, because the driver is assisted in the longitudinal guidance by the other active driver assistance systems and vehicle safety systems. The first disconnection condition may thus be satisfied, for example, when a further driver assistance system or vehicle safety system is activated. Driver assistance systems and vehicle safety systems in this context may include, for example, anti-lock braking systems (ABS), suspension stability systems (electronic stability control) influencing the dynamics of the suspension, driver assistance systems assisting with start-up on an incline, driver assistance systems limiting the speed to a top speed limit, driver assistance systems assisting with or performing emergency braking, systems for controlling engine drag torque, etc.

According to another advantageous feature of the present invention, one or more items of traveling route information about the route currently traveled by the motor vehicle and/or the future route to be traveled by the motor vehicle may be used as a first disconnection condition. Traveling route information is to be understood as including all information related to the route or path currently traveled by the motor vehicle and/or to be traveled by the motor vehicle in the future. This information may relate to, for example, the course of the route, i.e. for example curves, inclines, downhill sections, speed limits, environmental conditions, i.e. for example climate conditions, such as ice, rain, snow or obstacles ahead, such as accidents or traffic congestion. Corresponding traveling route information may, for example, be determined based on a predetermined route in a navigation system. Within the context of this embodiment of the method according to the invention, for example, a first disconnection condition may be deemed to be present for a defined travel route section ahead, when the motor vehicle travels a route with a downhill slope exceeding a certain threshold value, e.g. 18%.

According to another advantageous feature of the present invention, the first disconnection condition may relate to action information describing a certain action of at least one vehicle occupants, in particular of the driver, in particular action information describing opening of a door of the motor vehicle and/or a setting of an actuating element, especially a selector lever for selecting a gear of an automatic transmission. It is thus possible to prompt a vehicle occupant, in particular the driver, to disconnect the longitudinal guide when the first disconnection condition is present. This can for example be realized by determining with, for example, suitable sensor systems certain actions by the driver. For example, it the action information may describe when a vehicle door is opened as determined by a door sensor system or when an actuator is actuated, for example the selector lever for selecting a gear of an automatic transmission, as determined by an actuating sensor, and the action information descriptive of the driver's actions can be defined as the aforementioned disconnection condition. For example, an actuation of a respective selector lever from a forward gear into a reverse gear can be defined as the first disconnection condition, so that the longitudinal guidance function is disabled by a corresponding actuation of the selector lever. Therefore, certain actions by a vehicle occupant, which are not directly related to disconnecting the longitudinal guide of the driver assistance system, can be defined as the first disconnection condition.

The statements relating to the first disconnection condition apply likewise to the second disconnection condition and, if it is present, the additional disconnection of the transverse guidance function of the driver assistance system. This means that starting from the exclusive operation of the traverse guidance function, an individual or group-wise presence of the second shutdown condition can result in the additional disconnection or deactivation of the traverse guidance function of driver assistance system.

According to another advantageous feature of the present invention, a certain period of time elapsed after the longitudinal guidance function has been disconnected, i.e. when the first disconnection condition is present, and/or actual operating parameters of the motor vehicle, in particular driving speed and/or acceleration and deceleration values and/or the steering wheel angle of a steering device on the vehicle may be used as a second disconnection condition. Accordingly, the transverse guidance function may be disconnected as well, for example 30 seconds after the longitudinal guidance function is disconnected. Of course, the period of time may be shorter or longer. A second disconnection condition may also be satisfied, for example, when the speed of the motor vehicle drops below a certain speed, for example 10 km/h, or decelerates to less than a certain vehicle speed, i.e. when the acceleration is negative. Similarly, a second disconnection condition may be satisfied when the yaw rate of the vehicle falls below a predetermined value. This can, for example, also be expressed in small deviation of the steering wheel angle of a steering device of the motor vehicle in relation to a reference position describing driving in a straight line.

In principle, the transverse guidance function, which continues to be active after the longitudinal guidance function is disconnected, can be terminated by an override from the driver, for example, by an active steering intervention by the driver.

Advantageously, the longitudinal guidance function and, optionally, the additional transverse guidance function may be disconnected continuously over a certain period of time. Continuously disconnecting is to be understood as not being abrupt. The continuous and therefore ramped disconnection of the longitudinal guidance function and, if necessary, also of the traverse guidance function is more comfortable for the driver. The length of time it takes to continuously disconnect the longitudinal guidance function and optionally also the transverse guidance function may be, for example, five seconds.

Disconnecting the longitudinal guidance function and optionally also the transverse guidance function may optionally be indicated to the driver by suitable acoustic and/or visual and/or haptic signals. For example, a corresponding indication may be outputted on a display device on the vehicle while the longitudinal guidance function is continuously disconnected, with the intensity of the display changing, in particular decreasing, commensurate with the degree of the disconnection. Likewise, acoustic signals may be outputted, for example with loudspeakers, and/or haptic signals, for example in the form of steering wheel vibrations. The signals outputted when the longitudinal guidance function is switched on or is disconnected may be different.

The method according to the invention generally uses suitable control devices of the vehicle and the data or communication links within the motor vehicle implemented, for example, as a bus system. In particular, corresponding data required for determining the first and second disconnection condition are supplied and processed by a control device of the driver assistance system.

The invention further relates to a motor vehicle comprising a driver assistance system with a combined longitudinal and transverse guidance function. The motor vehicle has a control device which is configured to determine a first disconnection condition and to disconnect the longitudinal guidance function of the driver assistance system in response to the presence of the determined first disconnection condition.

Advantageously, the control device is furthermore configured to determine a second disconnection condition, and to additionally disconnect the transverse guidance function of the driver assistance system after disconnecting the longitudinal guidance function of the driver assistance system in response to the presence of the second disconnection condition.

Basically, all discussions relating to the method of the present invention apply equally to the vehicle according to the invention.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic diagram of a motor vehicle according to the invention according to an exemplary embodiment of the present invention; and

FIG. 2 is a block diagram to illustrate the method according to the invention according to an exemplary embodiment of the invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

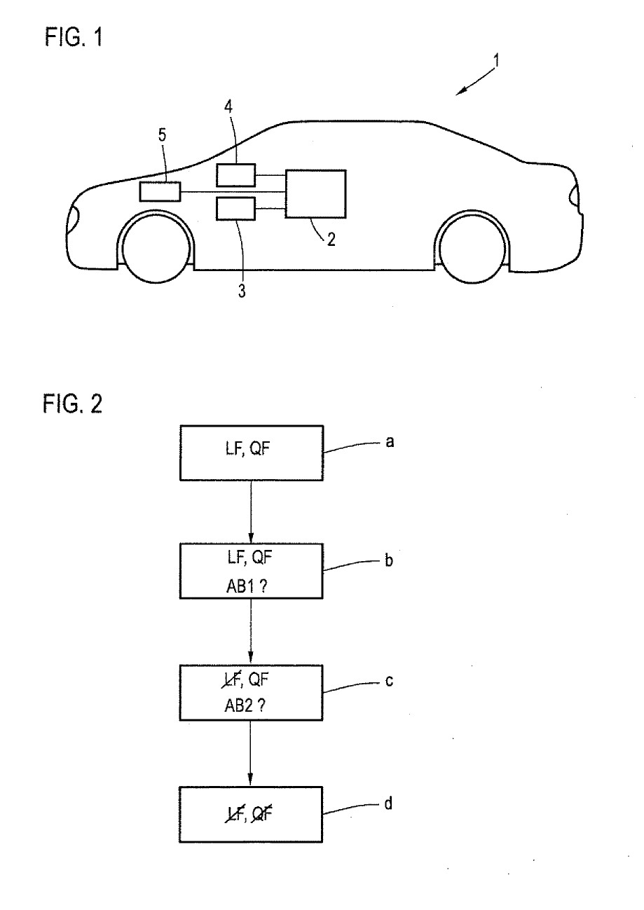

Turning now to the drawing, and in particular to FIG. 1, there is shown in form of a schematic diagram an exemplary embodiment of a motor vehicle 1 according to the invention. The motor vehicle 1 includes a driver assistance system, indicated only by the control device 2 associated with the driver assistance system, with a combined longitudinal guidance function LF and transverse guidance function QF. When the driver assistance system is active, it assists the driver in both the longitudinal and the transverse guidance of the motor vehicle 1. This control device 2 communicates with certain components of the drive train, such as a drive assembly 3 or an engine, a brake system 4 having a plurality of brakes, and a steering device 5 for steering the steerable front axle of the motor vehicle 1. The control device 2 communicates with controllers associated with various devices or components of the motor vehicle 1 via a vehicle bus.

FIG. 2 shows a block diagram for illustrating the method according to the invention according to an exemplary embodiment of the invention. The method is generally directed to the operation of a driver assistance system with a combined longitudinal and transverse guidance function of the motor vehicle 1. The method starts from an active state of the driver assistance system, i.e. both the longitudinal and the transverse guidance function is switched on or activated, so that the driver assistance system controls both the longitudinal guidance LF and the transverse guidance QF of the motor vehicle 1 (see Box a).

As indicated by the Box b, a first disconnection condition AB1 is determined or it is checked whether a first disconnection condition AB1 exists. The first disconnection condition AB1 may be, for example, a current operating parameter of the motor vehicle 1, such as a current engine speed. The operating parameter is retrieved by the control device 2 via the aforedescribed onboard bus system, via which the control device 2 communicates with an engine controller.

It is equally conceivable to classify the current driving situation of the motor vehicle 1 before determining a first disconnection condition AB1 in order to determine whether the longitudinal guidance function LF of driver assistance system should be disconnected prior to disconnecting the traverse guidance function QF, based on the presence of a first disconnection condition AB1. For this purpose, the control device 2 can check, for example, the current driving speed of the vehicle 1 or a steering wheel angle or steering wheel rotation of a steering wheel connected to the steering device 5, in order to determine whether the motor vehicle 1 is travelling in a curve. It is therefore determined based on the classification of the driving situation whether the longitudinal guidance function LF of the driver assistance system should be deactivated at all. It can also be established based on the classification that, in the presence of the first disconnection condition AB1, the transverse guidance function QF can simultaneously be disconnected in conjunction with the longitudinal guidance function LF, thereby completely deactivating the driver assistance system.

Within the context of the method, it is checked whether a previously defined continuously determined first disconnection condition AB1 is satisfied, for example, by a current operating parameter of the motor vehicle 1, such as the rotation speed of the drive unit 3. It is also conceivable to associate the presence of the first disconnection condition AB1 with additional parameters. These include, for example, operating states of the driver assistance system and/or of other driver assistance systems of the motor vehicle, such as engine drag torque control, and/or safety systems of the motor vehicle, such as an anti-lock braking system. The first disconnection condition AB1 can thus be present, when additional driver assistance systems and vehicle safety systems are enabled individually or in groups.

Travel route information concerning the route currently traveled by the motor vehicle 1 and/or to be traveled by the motor vehicle 1 in the future can be used as a first disconnection condition AB1. In this context, for example, inclines or downhill sections of the travel route ahead exceeding, for example, a certain inclination, e.g. 18%, of the route currently traveled by the motor vehicle 1 and/or to be traveled by the motor vehicle 1 in the future may be defined as the first disconnection condition AB1, based on which the longitudinal guidance function LF is disconnected. The travel route information may also describe, for example, obstacles lying ahead, such as traffic congestion, accidents, etc. Corresponding route information can be determined, for example, based on a route predetermined by a navigation system in the motor vehicle.

A first disconnection condition AB1 may also be present, for example, when a selector lever for a gear of an automatic transmission is operated as described by action information, such as a switch from a forward gear into reverse gear. Action information may also describe, for example, opening of a door of the motor vehicle 1 detected by a door sensor, which can also be defined as the first disconnection condition AB1.

When a first disconnection condition AB1 is present, the longitudinal guidance function LF of the driver assistance system is disconnected. The longitudinal guidance function LF is disconnected in dependence of the respective first disconnection condition AB1 in form of a ramp over a given time period, e.g. a time period of 10 seconds, so that the driver can more easily deal with the disconnection of the longitudinal guidance function LF. After the longitudinal guidance function LF has been disconnected, the driver assistance system assists the driver only with the transverse guidance of the motor vehicle 1. The transverse guidance function QF of the driver assistance system remains active independent of the longitudinal guidance function LF (see Box c).

After the longitudinal guidance function LF has been disconnected, a second disconnection condition AB2 is determined or it is checked whether a second disconnection condition AB2 is present (see Box c). When the second disconnection condition AB2 is present, the still active transverse guidance function QF of the driver assistance system is also disconnected. The second disconnection condition AB2 can be, for example, a certain time interval after disconnection of the longitudinal guidance function LF. The transverse guidance function QF can then be disconnected, for example, after a period of for example 30 seconds after disconnecting the longitudinal guidance function LF. The length of time for the additional disconnection of the transverse guidance function QF after disconnecting the longitudinal guidance function is typically set at the factory.

It is also conceivable to link the existence of the second disconnection condition AB2 to changes of certain operating parameters of the motor vehicle 1, such as the driving speed. A second disconnection condition can thus be satisfied, for example, when the speed of the motor vehicle 1 drops below a certain speed, for example 10 km/h, or when the motor vehicle 1 is decelerated below a certain vehicle speed, i.e. experiences a negative acceleration.

Similar to the disconnection of the longitudinal guidance function LF in response to the presence of the first disconnection condition AB1, disconnection of the transverse guidance function QF, when the second disconnection condition AB2 is present, is also continuously or in form of a ramp over a certain period of time, e.g. a period of three seconds. Accordingly, the driver is more comfortable when taking over the traverse guidance of the motor vehicle.

In principle, the transverse guidance function QF which continues to be active after the longitudinal guidance function LF has been disconnected can also be terminated by having the driver override the transverse guidance function QF with an active steering intervention.

Overall, the principle of the invention makes it possible to disable possible longitudinal and transverse guidance of a driver assistance system with a combined longitudinal guidance function LF and transverse guidance function QF of the motor vehicle 1 in stages. In a first stage, the longitudinal guidance function LF is initially disconnected in the presence of a first disconnection condition AB1, and in a subsequent second stage the transverse guidance function QF is additionally disconnected in response to the presence of a second disconnection condition AB2, which results in a complete deactivation of the driver assistance system (see Box d).

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A method for operating a driver assistance system of a motor vehicle having a combined longitudinal and transverse guidance function of the motor vehicle, comprising:
operating the longitudinal and transverse guidance function in combination, and
disconnecting the longitudinal guidance function in response to at least one first disconnection condition, while maintaining the transverse guidance function.

2. The method of claim 1, further comprising additionally disconnecting the transverse guidance function in response to a second disconnection condition after the longitudinal guidance function of the driver assistance system has been disconnected.

3. The method of claim 1, wherein the first disconnection condition comprises operating parameters of the motor vehicle.

4. The method of claim 3, wherein the operating parameters vehicle comprise at least one value selected from speed values, acceleration values, deceleration values and engine rotation speed values.

5. The method of claim 1, wherein the first disconnection condition comprises at least one condition selected from an operating condition of the driver assistance system, an operating condition of at least one additional driver assistance system of the vehicle, and an operating condition of a driving safety system.

6. The method of claim 1, wherein the first disconnection condition comprises at least one item of travel route information relating to a route currently traveled by the motor vehicle or a future route to be traveled by the motor vehicle.

7. The method of claim 1, wherein the first disconnection condition comprises action information describing a specific action by at least one vehicle occupant.

8. The method of claim 7, wherein the specific action is performed by the driver of the motor vehicle.

9. The method of claim 7, wherein the specific action includes opening of a door of the motor vehicle.

10. The method of claim 7, wherein the action information is descriptive of an adjustment of an actuating element.

11. The method of claim 2, wherein the second disconnection condition comprises passage of a certain period of time after disconnection of the longitudinal guidance function.

12. The method of claim 2, wherein the second disconnection condition comprises actual operating parameters of the motor vehicle.

13. The method of claim 12, wherein the actual operating parameters comprise parameters selected from a driving speed, an acceleration value, a deceleration value, a yaw rate, and a steering wheel angle of a steering device of the motor vehicle.

14. The method of claim 1, wherein the longitudinal guidance function is disconnected continuously over a specified period of time.

15. The method of claim 2, wherein the transverse guidance function is disconnected continuously over a specified period of time.

16. A motor vehicle comprising a driver assistance system having a combined longitudinal and transverse guidance function, comprising a control device configured to determine a first disconnection condition and to disconnect the longitudinal guidance function of the driver assistance system in response to presence of the determined first disconnection condition.

17. The motor vehicle of claim 16, wherein the control device is configured to determine a second disconnection condition, and to additionally disconnect, in response to presence of the second disconnection condition, the traverse guidance function of the driver assistance system after the longitudinal guidance function of the driver assistance system has been disconnected.
